(19) United States
(12) Patent Application Publication
(10) Pub. No.: US 2026/0097863 A1
(43) Pub. Date: Apr. 9, 2026

(54) DEVICE FOR GENERATING A VARIABLE ANGULAR MOMENTUM, PARTICULARLY FOR THE ATTITUDE CONTROL OF SPACECRAFT

(71) Applicant: Universität Stuttgart, Stuttgart (DE)

(72) Inventors: Manfred EHRESMANN, Stuttgart (DE); Georg Heinrich HERDRICH, Esslingen (DE); Stefanos FASOULAS, Neckartenzlingen (DE)

(73) Assignee: Universität Stuttgart, Stuttgart (DE)

(21) Appl. No.: 19/351,399

(22) Filed: Oct. 7, 2025

(30) Foreign Application Priority Data
Oct. 7, 2024 (EP) 24 204 927.8

(51) Int. Cl. B64G 1/28

(52) U.S. Cl. CPC B64G 1/283

(57) ABSTRACT

A device for generating a variable angular momentum for attitude control of a spacecraft includes a rotor and a stator on which the rotor is mounted and a means for driving the rotor via a rotating magnetic field. A bearing is formed by a fluid film of a ferrofluid between opposite bearing surfaces of the rotor and the stator. The fluid film is interrupted by one or more gas inclusions. The bearing preferably extends about the central axis over a region that has a smaller radius than the rotor. One or more permanent magnets are arranged on the rotor or on the stator in the region of the bearing, wherein the ferrofluid is held in a fixed position relative to the rotor or the stator and a magnetic pressure is generated in the ferrofluid by the one or more permanent magnets.

### CROSS-REFERENCE TO RELATED APPLICATION

This application is based upon and claims the benefit of priority from European Patent Application No. 24 204 927.8, filed Oct. 7, 2024, the entire contents of which are incorporated herein by reference.

### TECHNICAL FIELD OF APPLICATION

The present invention pertains to a device for generating a variable angular momentum that has a rotor and a stator, on which the rotor is mounted so as to be rotatable about a central axis by means of at least one bearing, and a means for driving the rotor via a rotating magnetic field. A device of this type can be used, for example, for the attitude control of spacecraft.

### PRIOR ART

In the operation of spacecraft, it is frequently required to provide the spacecraft with one or more devices that make it possible to purposefully change or correct the attitude of the spacecraft. This can be realized, for example, by means of a drive system of the spacecraft that generates an angular momentum due to an eccentric thrust. It is also known to equip spacecraft with mechanical momentum wheels and reaction wheels. In this case, an angular momentum is stored in a quickly rotating flywheel and transmitted to the spacecraft as needed by accelerating or decelerating the flywheel. The flywheel typically is mounted in a purely mechanical manner, e.g., by means of ball bearings that, however, only have a limited service life due to wear.

EP 3 904 220 B1 discloses a device for the attitude control of spacecraft, which comprises a receptacle that is partially filled with a magnetizable fluid and a means for generating one or more rotating or migrating magnetic fields, by means of which the magnetizable fluid in the receptacle can be continuously moved along a closed path. In this way, a variable angular momentum can be generated without mechanically moved parts or the need for external magnetic fields. However, the maximum speed and the maximum torque that can be generated with this device are limited.

A device for the attitude control of a spacecraft is known from N. Heinz et al., “The Student Project FARGO—A Ferrofluid Experiment on the ISS”, 74th International Astronautical Congress (IAC), Baku, Azerbaijan, Oct. 2-6, 2023, wherein said device has a rotor and a stator, on which the rotor is mounted so as to be rotatable about a central axis by means of at least one bearing, and a means for driving the rotor via a rotating magnetic field. In this case, the bearing is formed by a coherent fluid film of a ferrofluid between opposite bearing surfaces of the rotor and the stator. The bearing extends over the entire lateral extent of the rotor, on which permanent magnets wetted with the ferrofluid are arranged in a rotationally symmetric manner.

The present invention is based on the objective of making available a device with a rotor and a stator for the attitude control of a spacecraft, wherein said device does not require any external magnetic fields or additional fuel and makes it possible to generate and change a sufficiently high angular momentum or torque with lower frictional losses and greater bearing rigidity than the latter-mentioned device according to the prior art.

### DESCRIPTION OF THE INVENTION

The above-defined objective is attained with the device according to claim 1. Advantageous embodiments of the device form the subject matter of the dependent claims or can be gathered from the following description, as well as the exemplary embodiments.

The proposed device has a rotor and a stator, on which the rotor is mounted so as to be rotatable about a central axis by means of at least one bearing, and a means for driving the rotor by means of a rotating magnetic field. In the proposed device, the bearing is formed by a fluid film of a ferrofluid between opposite bearing surfaces of the rotor and the stator, wherein said fluid film is interrupted by one or more gas inclusions. In this case, the bearing preferably extends about the central axis over a region that preferably includes the central axis and has a smaller radius than the rotor, preferably a radius that is smaller than that of the rotor by at least the factor 2. One or more permanent magnets are arranged either on the rotor on the stator adjacent to the bearing, wherein the ferrofluid is held in a fixed position relative to the rotor or the stator and a magnetic pressure is generated in the ferrofluid by the permanent magnet or the permanent magnets.

No wear of mechanical components such as the balls of a ball bearing occurs in the device due to the use of a ferrofluid for the bearing. Consequently, the device is subjected to significantly less wear and therefore has a much longer service life and a much higher reliability than purely mechanical systems. In addition, no external magnetic fields or additional fuel is required for the operation of the device in a spacecraft. Since one or more gas inclusions are incorporated into the fluid film, the friction losses of the bearing are reduced in comparison with a bearing with a continuous fluid film because gas friction losses are lower than fluid friction losses. Furthermore, these gas inclusions also increase the bearing rigidity. Since the bearing according to the preferred embodiment has a smaller lateral extent than in the latter-mentioned prior art, friction losses occurring in the bearing according to the prior art due to the high speeds on the outer edge of the rotor are also reduced.

The bearing of the proposed device may be realized in different ways, e.g. in the form of a radial bearing, an axial bearing or a cone bearing. The configuration of the rotor and the stator may be realized in the form of an internal rotor, as well as in the form of an external rotor. The gas inclusion or gas inclusions, e.g. air inclusions, form gas cushions between the two bearing surfaces, wherein said gas cushions may be realized circumferentially (about the central axis), i.e. annularly, as well as in an interrupted manner such that several gas cushions are separated from one another in the circumferential direction. In order to form the bearing, the rotor and the stator form suitable bearing structures with the bearing surfaces, between which the fluid is introduced.

The means for driving the rotor preferably is formed by several electric coils that are arranged on the stator about the central axis and serve for generating the rotating magnetic field and by several permanent magnets of alternating polarity that are arranged on the rotor about the central axis as it is also known from asynchronous or synchronous machines according to the prior art. The device additionally comprises a control unit, by means of which a phase-shifted current flow through the electric coils can be generated and controlled or regulated.

A purposeful change of the rotational speed of the rotor by means of the rotating magnetic field of the electric coils changes the angular momentum of the rotor such that a torque is generated. If this device is used in a spacecraft, the angular momentum generated in this device transmits an inverse angular momentum to the spacecraft. This makes it possible to control the attitude and the orientation of the spacecraft in space.

One particular advantage of the device can be seen in that the ferrofluid used in the bearing is capable of repairing itself in case of a leak because the ferrofluid automatically distributes itself uniformly in the existing magnetic potential field of the permanent magnets.

The device may have only a single bearing or a bilateral bearing for the rotor. With respect to the design of the bearing, the permanent magnet or the permanent magnets for fixing the ferrofluid is/are arranged either on the rotor or on the stator. In this case, the respective structure lying opposite of the permanent magnets on the bearing should not be magnetic so as to not interfere with the formation of the bearing. The permanent magnets preferably are arranged on the stator because the ferrofluid is at relative rest in this case and no electromagnetic interferences occur due to moving permanent magnets on the bearing.

The device can be very advantageously used for the attitude control of spacecraft. However, it can, in principle, also be used for other applications, in which a variable angular momentum should be generated and transmitted, e.g. as an actuator on a robotic arm.

### BRIEF DESCRIPTION OF THE DRAWINGS

Exemplary embodiments of the proposed device are once again described in greater detail below with reference to the drawings. In these drawings:

FIG. 1 shows a trimetric view of an exemplary embodiment of the proposed device;

FIG. 2 shows a detailed view of the upper bearing in FIG. 1 in the form of a cross section;

FIG. 3 shows a schematic representation of another exemplary embodiment of the proposed device in the form of a top view;

FIG. 4 shows a schematic representation regarding the generation of the magnetic pressure in the ferrofluid; and

FIG. 5 shows a schematic representation of a potential design of the bearing in the proposed device.

### WAYS FOR IMPLEMENTING THE INVENTION

The proposed device has a rotating and a static structure, as well as at least one ferrofluidic bearing, by means of which the rotating structure, i.e. the rotor, is rotatably mounted on the static structure, i.e. the stator. Electric coils and a three-phase power supply for the coils are arranged on the stator. The coils on the stator are energized with the aid of the three-phase current in such a way that a rotating magnetic field is formed. The coupling of the angular momentum into the rotor takes place via alternating permanent magnets on the rotor. In the present device, the bearing has a fluid film of a ferrofluid that is under magnetic pressure and interrupted by one or more gas inclusions. The magnetic pressure is generated by means of one or more permanent magnets that are arranged on the rotor or on the stator in the region of the bearing and hold the ferrofluid in a fixed position relative to the rotor or the stator.

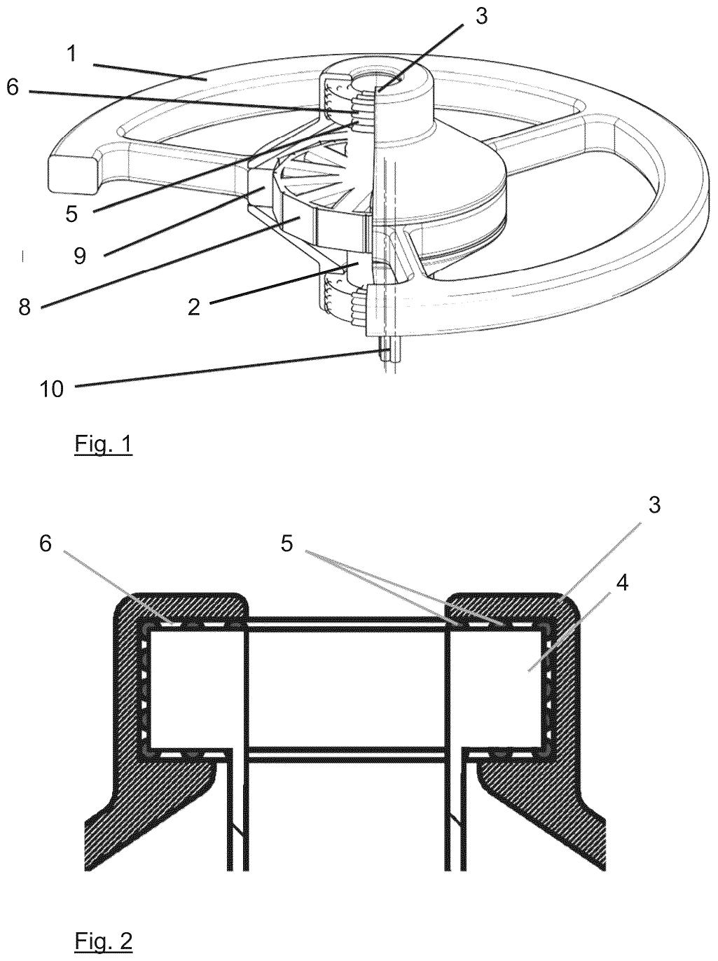

In this context, FIG. 1 shows an exemplary embodiment of the proposed device, in which the rotor 1 in the form of a flywheel, the stator 2 and the two bearings are illustrated in a trimetric view. In this example, the rotor 1 is mounted on the stator 2 by means of an upper and a lower bearing. The drive of the rotor is realized by means of electric coils 8 on the stator 2 and alternating permanent magnets 9 on the rotor 1, which lie opposite of the coils as indicated in the figure. This figure likewise shows the power supply 10 for the electric coils 8. The rotor bearing structure 3, which interacts with the stator bearing structure 4 in order to form the bearing, is illustrated on the upper bearing in the figure. A ferrofluid film that is interrupted by air inclusions is formed between the opposite bearing surfaces of the rotor bearing structure 3 and the stator bearing structure 4. In this context, FIG. 1 shows the ferrofluid 5 and the air cushions 6 located in between. The lower bearing is realized identically. This figure clearly shows that each bearing is in this embodiment formed in a region about the central axis of the device, i.e. each bearing only extends about the central axis in this narrow region and not over the entire extent of the rotor 1. In this way, the friction losses are kept low at higher rotational speeds.

FIG. 2 shows a detailed view of the upper bearing in FIG. 1 in the form of a cross section. The stator bearing structure 4, the rotor bearing structure 3, the ferrofluid 5 forming the ferrofluid bearing and the air cushions 6 in the ferrofluid film are illustrated in this figure. However, this figure and the preceding figure do not show the permanent magnets for fixing the ferrofluid 5 in the different positions, wherein said permanent magnets are arranged on the stator in the present example. Due to these permanent magnets, the ferrofluid is under magnetic pressure as described in greater detail below with reference to FIG. 4. The two bearing structures 3, 4 are designed in such a way that an axial and a lateral load absorption are possible. The closed air cushions 6 increase the bearing rigidity. The system is realized axially symmetrical.

In the proposed device, the bearing may be realized in the form of a single bearing and also in the form of a double bearing—as it is the case in FIG. 1. When a single bearing is used, it is important that this bearing can absorb axial loads in both directions and also cushion lateral loads. Such a bearing can be realized, for example, with a toroid magnet on the bearing structure of the stator or the rotor, wherein said toroid magnet is wetted with ferrofluid and has a central non-magnetic region, in which an air inclusion is formed after the attachment of a cover plate formed by the opposite bearing structure.

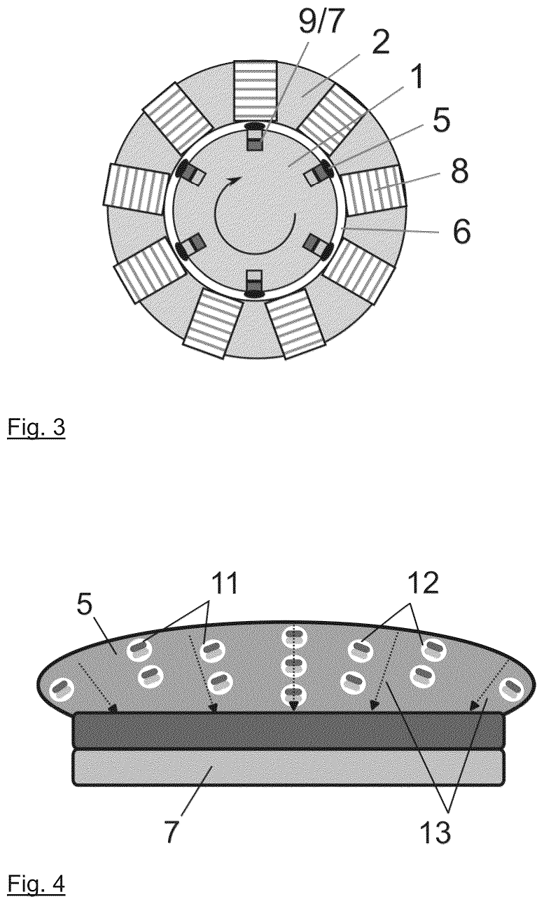

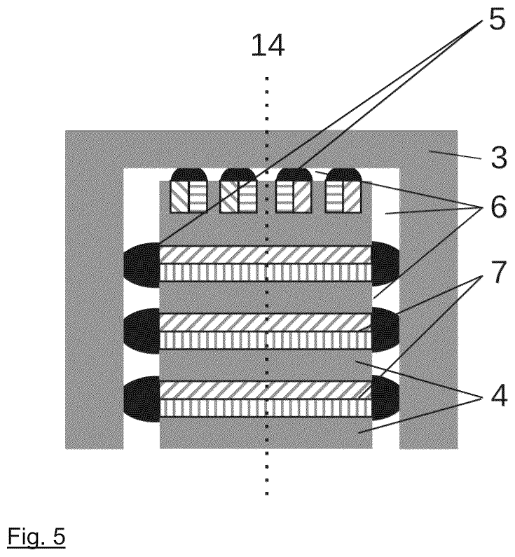

If the permanent magnets for the bearing are arranged on the rotor, these permanent magnets can, in principle, also be used as part of the electromagnetic drive as indicated, for example, in the schematic top view of the exemplary embodiment in FIG. 3. In this example, the stator 2 with the electric coils 8 is formed around the rotor 1. The alternating permanent magnets 9 on the rotor 1, which serve for driving the rotor 1, also fulfill the function of fixing the ferrofluid 5 of the bearing in this example as indicated in the figure. In the preferred embodiment of the inventive device, however, the permanent magnets for driving the rotor are arranged separately of the permanent magnets for fixing the ferrofluid in the bearing. In this way, the different components of the device can be suitably scaled independently of one another.

Ferrofluids of the type used in the proposed bearing are stable suspensions that contain magnetic particles with a size in the nanometer range. A hydrocarbon (ester, synthetic oil or mineral oil) typically is used as carrier fluid. The nanoparticles are coated with surface-active substances such that the suspension becomes stable. Supporting cushions can be generated by wetting the permanent magnets arranged on the bearing (or also a magnetically conductive coating or cover of these magnets) with the ferrofluid. FIG. 4 shows an illustration of the magnetic pressure (pressure gradient 13) used for the bearing. This figure shows a schematic representation of a permanent magnet 7, on which the ferrofluid 5 is located. The nanoparticles 11 coated with a surface-active substance 12, as well as the pressure gradient 13, are schematically illustrated in this figure. The magnetic nanoparticles 11 have the tendency to move to the location of the greatest magnetic field strength. This generates a magnetic pressure analogous to fluid particles in a gravitational field, which generate a static pressure. This magnetic pressure is sufficiently strong for overcoming the weight of permanent magnets and to thereby allow objects to float on a liquid cushion that is locally fixed on the magnet surface. Corresponding bearings can be constructed with suitable magnet geometries or arrangements of magnets.

The magnetic pressure in ferrofluids furthermore is selective for magnetic materials. Non-magnetic materials therefore are driven out of the fluid. Among other things, this makes a ferrofluidic bearing gas-tight and allows the purposeful inclusion of gas bubbles such that friction losses are minimized and the bearing rigidity is additionally increased in comparison with a ferrofluidic bearing without gas inclusions.

As an example, FIG. 4 once again shows a schematic representation of a potential embodiment of the bearing of the proposed device in the form of a cross section. The bearing structure 3 of the rotor and the bearing structure 4 of the stator are illustrated in this example. A film of ferrofluid 5, which is interrupted by air cushions 6, is formed between the opposite bearing surfaces. In this case, the ferrofluid 5 is held in a fixed position by means of the permanent magnets 7 arranged on the stator 2. The stator 2 and the rotor 1 or their respective bearing structures 3, 4 are made of a non-magnetic or demagnetized material in this case, e.g. of carbon fiber or Al—Ti. The stator bearing structure 4 is realized cylindrically in this figure. A portion of the permanent magnets 7 is arranged in such a way that several annular beads or cushions of the ferrofluid 5 are formed on the cylinder surface. The air cushions 6, which likewise extend annularly around the central axis 14 in this example, lie in between these beads or cushions. The permanent magnets 7 on the upper top surface of the cylindrical stator bearing structure 4 are arranged in such a way that individual pockets or strips of the ferrofluid 5 are formed, wherein air cushions 6 once again lie between these individual pockets or strips.

### LIST OF REFERENCE SYMBOLS

1 Rotor
2 Stator
3 Rotor bearing structure
4 Stator bearing structure
5 Ferrofluid
6 Air cushion
7 Permanent magnets for bearing
8 Electric coils on stator
9 Alternating permanent magnets on rotor
10 Power supply
11 Nanoparticles
12 Surface-active substance
13 Pressure gradient
14 Central axis

1. A device for generating a variable angular momentum, particularly for the attitude control of a spacecraft, said device comprising:
a rotor and a stator, on which the rotor is mounted so as to be rotatable about a central axis by at least one bearing; and
an electric coil assembly configured to drive the rotor via a rotating magnetic field,
wherein the at least one bearing is formed by a fluid film of a ferrofluid between opposite bearing surfaces of the rotor and the stator,
one or more permanent magnets are arranged on the rotor or on the stator adjacent to the bearing to hold the ferrofluid in a fixed position relative to the rotor or the stator, and generate a magnetic pressure in the ferrofluid, and
the fluid film of the ferrofluid forming the bearing is interrupted by one or more gas inclusions.

2. The device according to claim 1,
wherein the bearing extends about the central axis over a region that has a smaller radius than the rotor.

3. The device according to claim 1, wherein the electric coil assembly includes
a plurality of electric coils are arranged on the stator about the central axis and generate the rotating magnetic field, and
a plurality of alternating permanent magnets, which are arranged on the rotor about the central axis.

4. The device according to claim 3, further comprising:
a control circuit configured to generate and control or regulate a phase-shifted current flow through the plurality of electric coils.

5. The device according to claim 1, wherein the one or more gas inclusions are air inclusions.

6. The device according to claim 1, wherein the region about the central axis, over which the bearing extends, has a radius that is smaller than that of the rotor by at least a factor of 2.

7. The device according to claim 1, wherein the bearing surface of the stator is formed by a cylindrical stator bearing structure and at least a portion of the permanent magnets bordering on the bearing is arranged in such a way that a portion of the ferrofluid of the bearing extends about the central axis on a cylinder surface of the stator bearing structure in the form of several annular beads, which alternate with annular gas inclusions.
